(19) United States
(12) Patent Application Publication
(10) Pub. No.: US 2024/0107562 A1
(43) Pub. Date: Mar. 28, 2024

(54) INFORMATION TRANSMISSION AND INDICATION METHOD AND APPARATUS, AND COMMUNICATIONS DEVICE

(71) Applicant: VIVO MOBILE COMMUNICATION CO., LTD., Dongguan (CN)

(72) Inventors: Siqi LIU, Dongguan (CN); Zichao JI, Dongguan (CN)

(73) Assignee: VIVO MOBILE COMMUNICATION CO., LTD., Dongguan (CN)

(21) Appl. No.: 18/528,756

(22) Filed: Dec. 4, 2023

Related U.S. Application Data
(63) Continuation of application No. PCT/CN2022/096601, filed on Jun. 1, 2022.

(30) Foreign Application Priority Data
Jun. 7, 2021 (CN) 202110633825.7

(51) Int. Cl. H04W 72/40; H04L 5/00

(52) U.S. Cl. CPC H04W 72/40; H04L 5/0037; H04L 5/0094

(57) ABSTRACT

This application discloses an information transmission and indication method and a communications device. The method includes: sensing, by a terminal, a resource of first information on an unlicensed band or a shared band, or performing a transmission of first information, where the first information includes at least one of the following: N1 pieces of first SL information in frequency division multiplexing (FDM), where N1>1; N pieces of first information in FDM, where the N pieces of first information include N2 pieces of first SL information and N-N2 pieces of second information, N>1, and N2≥1; first SL information based on a first parameter; or first SL information within a first preset time, where at least one first transmission exists within the first preset time, and the first SL information includes a synchronization signal, a broadcast channel, or a synchronization signal block.

### CROSS-REFERENCE TO RELATED APPLICATIONS

This application is a continuation of International Application No. PCT/CN2022/096601, filed Jun. 1, 2022, which claims priority to Chinese Patent Application No. 202110633825.7, filed Jun. 7, 2021. The entire contents of each of the above-referenced applications are expressly incorporated herein by reference.

### TECHNICAL FIELD

The present application relates to the field of communications technologies, and in particular, to an information transmission and indication method and apparatus, and a communications device.

### BACKGROUND

To obtain more resources to meet a service requirement of Side Link (SL) transmission (such as Extended Reality (XR), Virtual Reality (VR), and other services that are based on SL). SL transmission may need to be performed on an unlicensed band. However, the current SL technical framework is mostly designed for the licensed band or the Intelligent Traffic System (ITS) band (the SL dedicated band). In this way, when the SL synchronization signal, the broadcast channel, or the synchronization signal block is transmitted on the unlicensed band, a regulation such as Occupied Channel Bandwidth (OCB) should be satisfied.

### SUMMARY

Embodiments of this application provide an information transmission and indication method and apparatus, and a communications device.

According to a first aspect, an information transmission method is provided, including:
sensing, by a terminal, a resource of first information on an unlicensed band or a shared band, and/or performing a transmission of first information, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2≥1;
first SL information based on a first parameter; or
first SL information within a first preset time, where at least one first transmission exists within the first preset time, where
the first SL information includes a synchronization signal, a broadcast channel, or a synchronization signal block.

According to a second aspect, an information indication method is provided, including:
instructing, by a network side device, a terminal to sense a resource of first information on an unlicensed band or a shared band, and/or perform a transmission of first information, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2≥1;
first SL information based on a first parameter; or
first SL information within a first preset time, where at least one first transmission exists within the first preset time, where
the first SL information includes a synchronization signal, a broadcast channel, or a synchronization signal block.

According to a third aspect, an information transmission apparatus is provided, including:
a first processing module, configured to: sense a resource of first information on an unlicensed band or a shared band, and/or perform a transmission of first information, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2>1;
first SL information based on a first parameter; or
first SL information within a first preset time, where at least one first transmission exists within the first preset time, where
the first SL information includes a synchronization signal, a broadcast channel, or a synchronization signal block.

According to a fourth aspect, an information indication apparatus is provided, including:
a first indication module, configured to: instruct a terminal to sense a resource of first information on an unlicensed band or a shared band, and/or perform a transmission of first information, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2≥1:
first SL information based on a first parameter; or
first SL information within a first preset time, where at least one first transmission exists within the first preset time, where
the first SL information includes a synchronization signal, a broadcast channel, or a synchronization signal block.

According to a fifth aspect, a terminal is provided. The terminal includes a processor, a memory, and a program or an instruction stored in the memory and executable on the processor, where the program or the instruction is executed by the processor to implement the steps of the method according to the first aspect.

According to a sixth aspect, a terminal is provided, including a processor and a communications interface, where the processor is configured to sense a resource of first information on an unlicensed band or a shared band, and/or the communications interface is configured to perform a transmission of first information on an unlicensed band or a shared band, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2>1;
first SL information based on a first parameter; or
first SL information within a first preset time, where at least one first transmission exists within the first preset time, where
the first SL information includes a synchronization signal, a broadcast channel, or a synchronization signal block.

According to a seventh aspect, a network side device is provided. The network side device includes a processor, a memory, and a program or an instruction stored in the memory and executable on the processor, where the program or the instruction is executed by the processor to implement the steps of the method according to the second aspect.

According to an eighth aspect, a network side device is provided, including a processor and a communications interface, where the processor is configured to: instruct a terminal to sense a resource of first information on an unlicensed band or a shared band, and/or perform a transmission of first information, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2≥1;
first SL information based on a first parameter; or
first SL information within a first preset time, where at least one first transmission exists within the first preset time, where
the first SL information includes a synchronization signal, a broadcast channel, or a synchronization signal block.

According to a ninth aspect, a readable storage medium is provided. The readable storage medium stores a program or an instruction, and when the program or the instruction is executed by a processor, steps of the method according to the first aspect or steps of the method according to the second aspect are implemented.

According to a tenth aspect, a chip is provided. The chip includes a processor and a communications interface, the communications interface is coupled to the processor, and the processor is configured to run a program or an instruction to implement the method according to the first aspect or the method according to the second aspect.

According to an eleventh aspect, a computer program/program product is provided, where the computer program/program product is stored in a storage medium, and the program/program product is executed by at least one processor to implement steps of the method according to the first aspect or the second aspect.

According to a twelfth aspect, a communications device is provided, configured to perform steps of the method according to the first aspect or steps of the method according to the second aspect.

In this embodiment of this application, the resource of the first information is sensed on the unlicensed band or the shared band, and/or the first information is transmitted, where the first information is SL information meeting the specific condition, for example, N1 pieces of first SL information in FDM, and for example, the first SL information based on the first parameter; for another example, the first SL information within the first preset time, where at least one first transmission exists within the first preset time; and N pieces of first information in FDM. The first information meeting the specific condition can meet the first transmission requirement by itself, or the first information can be SL information transmitted together with the first transmission meeting the first transmission requirement, so that the first transmission requirement can be met when the first information meeting the specific condition is transmitted on the unlicensed band or the shared band, such as meeting the OCB requirement.

### BRIEF DESCRIPTION OF DRAWINGS

FIG. 1 is a structural diagram of a communications system to which embodiments of this application can be applied:

FIG. 2 is a flowchart of an information transmission method according to an embodiment of this application;

FIG. 3 is a schematic diagram of first SL information and second information according to an embodiment of this application;

FIG. 4 is a first schematic diagram of a specific SCS and a first SCS according to an embodiment of this application:

FIG. 5 is a second schematic diagram of a specific SCS and a first SCS according to an embodiment of this application;

FIG. 6 is a third schematic diagram of a specific SCS and a first SCS according to an embodiment of this application;

FIG. 7 is a flowchart of an information indication method according to an embodiment of this application:

FIG. 8 is a schematic diagram of modules of an information transmission apparatus according to an embodiment of this application;

FIG. 9 is a structural block diagram of a communications device according to an embodiment of this application;

FIG. 10 is a structural block diagram of a terminal according to an embodiment of this application;

FIG. 11 is a schematic diagram of modules of an information indication apparatus according to an embodiment of this application; and

FIG. 12 is a structural block diagram of a network side device according to an embodiment of this application.

### DETAILED DESCRIPTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”. “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and the character “i” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. A New Radio (NR) system is described below for an illustration purpose, and the term NR is used in most of the descriptions, although these technologies can also be used in an application other than an NR system application, for example, a 6G Generation (6G) communications system.

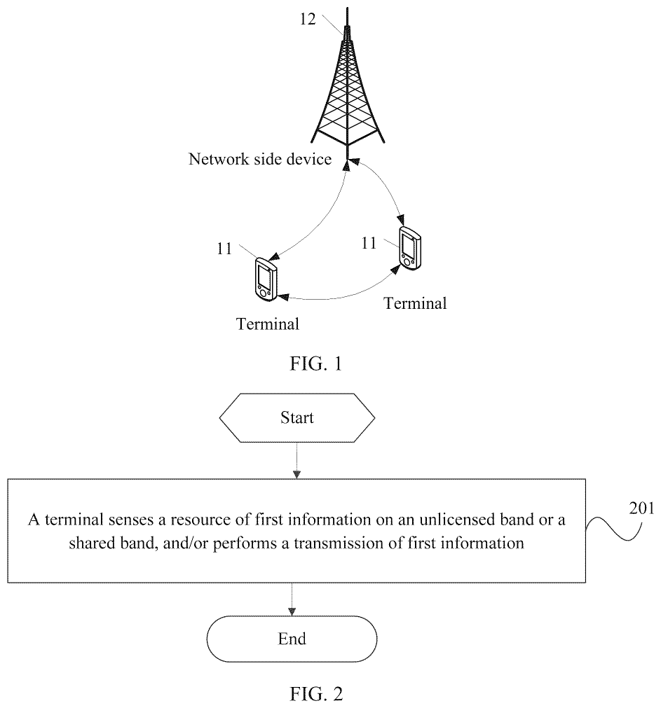

FIG. 1 is a structural diagram of a wireless communications system to which embodiments of this application can be applied. The wireless communications system includes a terminal 1I and a network side device 12. The terminal 11 may also be referred to as a terminal device or User Equipment (UE). The terminal 11 may be a terminal side device such as a mobile phone, a tablet computer, a laptop computer or a notebook computer, a Personal Digital Assistant (PDA), a palmtop computer, a netbook, an ultra-mobile personal computer (UMPC), a mobile Internet device (MID), a wearable device, vehicle user equipment (VUE), or pedestrian user equipment (PUE). The wearable device includes a smartwatch, a bracelet, a headset, glasses, and the like. It should be noted that a specific type of the terminal 11 is not limited in the embodiments of this application. The network side device 12 may be a base station or a core network device. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

The following describes in detail the information transmission method provided in the embodiments of this application through some embodiments and application scenarios thereof with reference to the accompanying drawings.

As shown in FIG. 2, an embodiment of this application provides an information transmission method, including the following steps.

Step 201: A terminal senses a resource of first information on an unlicensed band or a shared band, and/or transmits first information.

The first information includes at least one of the following:
Item 1; N1 pieces of first SL information in Frequency Division Multiplexing (FDM)), where N1>1;
Item 2: N pieces of first information in FDM, where the N pieces of first information include N2 pieces of first SL information and N−N2 pieces of second information, N>1, and N2≥1;
Item 3: first SL information based on a first parameter; or
Item 4: first SL information within a first preset time, where at least one first transmission exists within the first preset time, where
the first SL information includes a synchronization signal, a broadcast channel, or a synchronization signal block.

In some embodiments, the first information meets a first transmission requirement, and/or the first transmission meets the first transmission requirement.

In some embodiments, at least one of the first information or the second information meets the first transmission requirement, for example, a bandwidth span occupied by N1 pieces of first SL information is greater than or equal to a preset percentage of nominal channel bandwidth; or a bandwidth span occupied by the first SL information and the second information is greater than or equal to a preset percentage of nominal channel bandwidth, or a bandwidth span occupied by the first transmission is greater than or equal to a preset percentage of nominal channel bandwidth.

N, N1, and N2 are determined based on the first transmission requirement.

Herein, the first information is information that meets a specific condition, for example, the first information itself meets the first transmission requirement, or the first information and the first transmission meeting the first transmission requirement are jointly transmitted within a first preset time. In addition, it should be noted that the synchronization signal and the broadcast information may meet same or different conditions. For example, the synchronization signal is a synchronization signal transmitted based on the first parameter, and the broadcast information is broadcast information within the first preset time.

In addition, the N1 pieces of first SL information in frequency division multiplexing may also be described as time domain overlap of the N1 pieces of first SL information; and the N pieces of first information in FDM may also be described as time domain overlap of the N pieces of first information.

In some embodiments, the first transmission requirement may be OCB, and may also be another transmission requirement. In the following, this application takes OCB as the first transmission requirement as an example for illustration. The OCB refers to that in an unlicensed band, when a device transmits a signal in an occupied resource, it needs to be ensured that within one nominal channel bandwidth (for example, 20 MHz or 10 MHz, and bandwidths are different in different countries and regions), the frequency domain span of power distribution is not less than a preset percentage of the nominal channel bandwidth, for example, 99% frequency domain span of power distribution within the nominal channel bandwidth is not less than 80% of the nominal channel bandwidth. For example, bandwidth occupied by the N1 pieces of first SL information in FDM on the unlicensed band or the shared band is greater than or equal to 80% of the unlicensed band; and bandwidth occupied by the N pieces of first information in FDM on the unlicensed band or the shared band is greater than or equal to 80% of the unlicensed band.

In this embodiment of this application, the resource of the first information is sensed on the unlicensed band or the shared band, and/or the first information is transmitted, where the first information is SL information meeting the specific condition, for example, N1 pieces of first SL information in FDM, and for example, the first SL information based on the first parameter: for another example, the first SL information within the first preset time, where at least one first transmission exists within the first preset time; and N pieces of first information in FDM. The first information meeting the specific condition can meet the first transmission requirement by itself, or the first information can be SL information transmitted together with the first transmission meeting the first transmission requirement, so that the first transmission requirement can be met when the first information meeting the specific condition is transmitted on the unlicensed band or the shared band, such as meeting the OCB requirement.

For Item 1, the N1 pieces of first SL information are transmitted or repeated in an FDM manner to ensure that OCB is met. That is, it is ensured that the frequency domain span of the N1 pieces of first SL information (for example, a span between first SL information in the highest frequency domain and first SL information in the lowest frequency domain, or a span between some two pieces of first SL information) meets OCB.

The method in this embodiment of this application further includes:
obtaining at least one item of third information through a first obtaining manner, where
the third information includes at least one of the following:
N1;
G1, where G1 is a frequency domain interval between any adjacent first SL information or specific adjacent first SL information in the N1 pieces of first SL information;
a frequency domain position of first SL information;
a number of first SL information;
N;
N2;
G2, where G2 is a frequency domain interval between any adjacent first information or specific adjacent first information in the N pieces of first information, for example, G2 is a frequency domain interval between any adjacent two pieces of first SL information or specific adjacent two pieces of first SL information, or G2 is a frequency domain interval between any adjacent second information or specific adjacent second information, or G2 is a frequency domain interval between any adjacent first SL information and second information or specific adjacent first SL information and second information;
a frequency domain position of second information:
a type of second information;
bandwidth of second information;
a number of second information;
a structure of second information, such as whether the second information is repeated, how many times it has been repeated, whether an interlace is used, a number of the interlace used, the interlace used is Yl frequency domain resource units separated by Xl frequency domain resource units, and other information;
a first parameter; and
indication information, where the indication information is used to indicate whether a transmission of the first SL information is based on the first parameter, where
the first obtaining manner includes at least one of the following:
being configured by a control node;
being determined by the terminal:
being preconfigured:
being predefined, or
being indicated by another terminal.

The control node refers to a device with scheduling capability or control capability, and may be at least one of NR base station. LTE base station, Road Side Unit (RSU), scheduling UE, header UE, or vehicle head.

In some embodiments, determining G1 by the terminal includes:

determining, by the terminal, G1 based on first bandwidth and N1, where the first bandwidth is bandwidth associated with the first SL information.

The first bandwidth is channel bandwidth or nominal channel bandwidth or system bandwidth or total bandwidth or carrier bandwidth or Bandwidth Part (BWP) bandwidth or cell bandwidth or resource pool bandwidth or subchannel bandwidth associated with the first SL information, or the first bandwidth is a product of channel bandwidth or nominal channel bandwidth or system bandwidth or total bandwidth or carrier bandwidth or BWP bandwidth or cell bandwidth or resource pool bandwidth or subchannel bandwidth associated with the first SL information and a preset ratio. In some embodiments, the preset ratio is related to the OCB requirement, such as 80%.

In some embodiments, G1 determined by being configured, preconfigured, or predefined by a control node is greater than or equal to a first preset value. The first preset value may be G1 determined based on the first bandwidth and N1.

In some embodiments, the determining, by the terminal, G1 based on first bandwidth and N1 includes.
determining, by the terminal, G1 by using at least one of the following formulas:

G1=(first bandwidth÷N1);

G1=floor(first bandwidth÷N1), where floor is rounded down; or

G1=ceil(first bandwidth÷N1), where ceil is rounded up.

In some embodiments of this application, G1 that is preconfigured, configured, predefined, and determined needs to ensure to be ≥floor (first bandwidth÷N1); or

G1 that is preconfigured, configured, predefined, and determined needs to ensure to be ≥ceil (first bandwidth÷N1); or

G1 that is preconfigured, configured, predefined, and determined needs to ensure to be >(first bandwidth÷N1).

In some embodiments, N1 pieces of first SL information are N1 pieces of same first SL information; or

at least M pieces of first SL information among N1 pieces of first SL information are at least partially different, where M>1.

For example, the M pieces of first SL information have different sequences or carry different contents.

When the N1 pieces of first SL information are N1 pieces of same first SL information, transmitting N1 broadcast channels can be interpreted as repeatedly mapping a Physical SideLink Broadcast Channel (PSBCH) for N1 times in the frequency domain.

See Table 1 for some possible values of N1. It is assumed that the bandwidth corresponding to the first SL information is 11 RB. When the first bandwidth=10 MHz or 8 MHz, 8 MHz is obtained by 10 MHz*80%; when the first bandwidth=20 MHz or 16 MHz, 16 MHz is obtained by 20 MHz*80%; when the first bandwidth=30 MHz or 24 MHz, 24 MHz is obtained by 30 MHz*80%; when the first bandwidth=40 MHz or 32 MHz, 32 MHz is obtained by 40 MHz*80%; when the first bandwidth=80 MHz or 64 MHz, 64 MHz is obtained by 80 MHz*80%, and when the first bandwidth=130-160 MHz or ≤128 MHz, 128 is obtained by 16 MHz*80%.

TABLE 1

| | 15 | 30 | 60 | 120 | 240 | 480 | 960 |
|---|---|---|---|---|---|---|---|
| First SCS | kHz | kHz | kHz | kHz | kHz | kHz | kHz |
| First | N1 = 2, | N1 = 2 | N1 = 1 | / | / | / | / |
| band- | 3, 4, 5 | | | | | | |
| width = | | | | | | | |
| 10 MHz or | | | | | | | |
| 8 MHz | | | | | | | |
| First | N1 = 2, | N1 = 2, | N1 = 2 | N1 = 1 | / | / | / |
| band- | 3, . . . , | 3, . . . , | | | | | |
| width = | 10 | 5 | | | | | |
| 20 MHz or | | | | | | | |
| 16 MHz | | | | | | | |
| First | N1 = 2, | N1 = 2, | N1 = 2, | / | / | / | / |
| band- | 3, . . . , | 3, . . . , | 3 | | | | |
| width = | 15 | 7 | | | | | |
| 30 MHz or | | | | | | | |
| 24 MHz | | | | | | | |
| First | N1 = 2, | N1 = 2, | N1 = 2, | N1 = 2 | N1 = 1 | / | / |
| band- | 3, . . . , | 3, . . . , | 3, . . . , | | | | |
| width = | 20 | 10 | 5 | | | | |
| 40 MHz or | | | | | | | |
| 32 MHz | | | | | | | |
| First | N1 = 2, | N1 = 2, | N1 = 2, | N1 = 2, | N1 = 2 | N1 = | / |
| band- | 3, . . . , | 3, . . . , | 3, . . . , | 5 | | 1 | |
| width = | 40 | 20 | 10 | | | | |
| 80 MHz or | | | | | | | |
| 64 MHz | | | | | | | |
| First | N1,= 2, | N1 = 2, | N1 = 2, | N1 = 2, | N1 = 2, | N1 = | N1 = |
| band- | 3, . . . , | 3, . . . , | 3, . . . , | 3, . . . , | 5 | 2 | 1 |
| width = | 80 | 40 | 20 | 10 | | | |
| 130-160 | | | | | | | |
| MHz or | | | | | | | |
| ≤128 MHz | | | | | | | |

For example, as shown in Table 1, when the first SCS is 15 kHz, and the first bandwidth is 20 MHz. N1 can be 2, 3, 4, 5, . . . , 10, and when the first SCS is 60 kHz. and the first bandwidth is 24 MHz, N1 can be 2 or 3.

For Item 2, the N pieces of first information are transmitted in an FDM manner to meet the OCB requirement. That the N pieces of first information meet the OCB requirement includes at least one of the following:
a frequency domain span between first SL information and second information meets the OCB requirement;
a frequency domain span between two pieces of first SL information meets the OCB requirement; or
a frequency domain span between two pieces of second information meets the OCB requirement.

Details are as follows:
a frequency domain span between first SL information with the highest frequency domain and second information with the lowest frequency domain meets the OCB requirement;
a frequency domain span between first SL information with the lowest frequency domain and second information with the highest frequency domain meets the OCB requirement;
a frequency domain span between two pieces of second information with the highest and lowest frequency domains respectively meets the OCB requirement; and
a frequency domain span between two pieces of first SL information with the highest and lowest frequency domains respectively meets the OCB requirement.

In some embodiments, the second information includes at least one of the following:
a Physical SideLink Control Channel (PSCCH);
a Physical SideLink Shared Channel (PSSCH);
a Physical SideLink Feedback Channel (PSFCH);
a Reference Signal (RS);
an LTE SL signal, for example, at least one of a Primary Sidelink Synchronization Signal (PSSS), a Secondary Sidelink Synchronization Signal (SSSS), or an LTE Physical SideLink Broadcast Channel (PSBCH):
a redundant sequence or a redundant message;
a frequency domain interval between any adjacent first information or specific adjacent first information; or
a channel of Uu, a signal of Uu, or transmission of Uu.

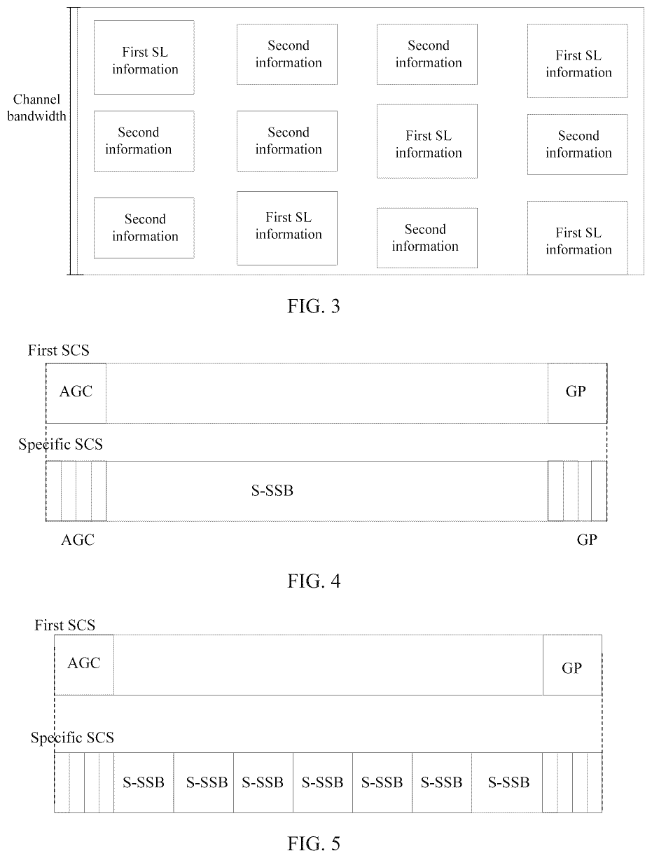

For Item 2, as shown in FIG. 3, frequency division multiplexing is performed on the first SL information and the second information to meet the OCB.

For Item 3, the first parameter includes at least one of the following:
a specific Sub-Carrier Space (SCS);
a specific Cyclic Prefix (CP);
a first SL sequence;
a specific frequency domain, where the specific frequency domain includes X frequency domain resource units;
a specific multiplexing manner, where the specific multiplexing manner is frequency division multiplexing of a synchronization signal and a broadcast channel: or
an interlace.

In some embodiments, the transmitting the SL information includes:
performing a transmission of the first SL information based on the first parameter when it is satisfied that an SCS of an object associated with the first SL information is a first SCS, bandwidth associated with the first SL information is second bandwidth, and a frequency domain associated with the first SL information is at least one item of a first frequency domain, where
the object associated with the first SL information is SL data, a control channel, or a feedback channel associated with the first SL information, or the object associated with the first SL information is a carrier, a cell, a BWP, an SL resource pool, or a subchannel associated with the first SL information.

The second bandwidth is channel bandwidth or nominal channel bandwidth or system bandwidth or total bandwidth or carrier bandwidth or BWP bandwidth or cell bandwidth or resource pool bandwidth or subchannel bandwidth associated with the first SL information, or the second bandwidth is a product of channel bandwidth or nominal channel bandwidth or system bandwidth or total bandwidth or carrier bandwidth or BWP bandwidth or cell bandwidth or resource pool bandwidth or subchannel bandwidth associated with the first SL information and a preset ratio. In some embodiments, the preset ratio is related to the OCB requirement, such as 80%.

The “associated” can also be interpreted as “located”. For example, the carrier or cell or BWP or SL resource pool or subchannel associated with the first SL information can also be interpreted as the carrier or cell or BWP or SL resource pool or subchannel where the first SL information is located.

In some embodiments, a time unit corresponding to the first SCS includes W pieces of first SL information or W candidate positions of the first SL information, and W≥1.

In some embodiments, if the specific SCS is different from the first SCS, a time unit corresponding to the first SCS includes W pieces of first SL information or W candidate positions of the first SL information, and W≥1.

Further, as shown in FIG. 4, when W=1, duration corresponding to the first SL information or duration corresponding to the candidate position of the first SL information is duration of the time unit corresponding to the first SCS, or duration corresponding to the first SL information or duration corresponding to the candidate position of the first SL information is equal to duration of the time unit corresponding to the first SCS obtained after removing at least one of first duration or second duration, where

the first duration includes duration required for at least one of automatic gain control (AGC) or power adjustment, and the second duration includes duration required for at least one of a guard period (GP), radio frequency (RF) adjustment, or receive/transmit transition.

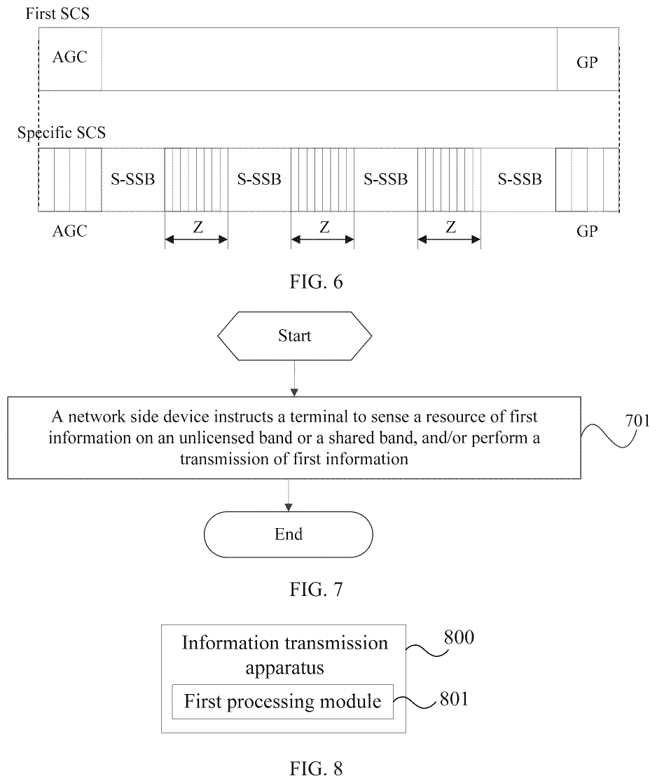

Further, when W>1, a time interval between any adjacent pieces of first SL information or candidate positions of the first SL information or between specific two adjacent pieces of first SL information or candidate positions of the first SL information in the time unit corresponding to the first SCS is 0 (as shown in FIG. 5) or Z (as shown in FIG. 6), where Z includes duration required for at least one of first duration or second duration, and a resource corresponding to Z may not be used for transmission, but for AGC and/or GP.

The first duration includes duration required for at least one of automatic gain control (AGC) or power adjustment, and the second duration includes duration required for at least one of a guard period (GP). RF adjustment, or receive/transmit transition.

In Item 3, the duration of the interval Z includes at least the duration required for at least one of the first duration or the second duration. For example, if each of the first duration and the second duration needs two symbols of 60 kHz, a length of Z is at least four symbols of 60 kHz.

The time unit includes at least one time slot, symbol, period, subframe, or frame. The time unit corresponding to the first SCS can also be interpreted as an SL symbol included in a time slot corresponding to the first SCS. For example, if a symbol 7 to a symbol 13 are used for SL, the time unit corresponding to the first SCS is the symbol 7 to the symbol 13.

In some embodiments, (the specific SCS is different from the first SCS) a time corresponding to a target subunit in a time unit (or in a time unit that is corresponding to the first SCS and in which the first SL information is located or in a time unit that is corresponding to the first SCS and in which the candidate position of the first SL information is located) in which the first SL information or the candidate position of the first SL information is located is less than or equal to a time corresponding to a target subunit in a time unit corresponding to the first SCS, the target subunit includes at least one of first duration or second duration, the first duration includes duration required for at least one of automatic gain control (AGC) or power adjustment, and the second duration includes duration required for at least one of a guard period (GP), RF adjustment, or receive/transmit transition.

The time corresponding to the target subunit in the time unit in which the first SL information or the candidate position of the first SL information is located is equal to the time corresponding to the target subunit in the time unit corresponding to the first SCS, which can be interpreted as at least one of the following:
a starting position of the target subunit in the time unit in which the first SL information or the candidate position of the first SL information is located is the same as a starting position corresponding to the target subunit in the time unit corresponding to the first SCS:
an end position of the target subunit in the time unit in which the first SL information or the candidate position of the first SL information is located is the same as an end position corresponding to the target subunit in the time unit corresponding to the first SCS; or
duration of the target subunit in the time unit in which the first SL information or the candidate position of the first SL information is located is the same as duration of the target subunit in the time unit corresponding to the first SCS.

For example, the first SCS=15 kHz, the specific SCS=60 kHz, and a GP symbol in the slot corresponding to 15 kHz is located at the last (15 kHz) symbol of the slot, then the last four (60 kHz) symbols included in the 60 kHz slot where S-SSB is located are used for GP.

In some embodiments, the specific SCS is greater than the first SCS.

In Item 3, combination of the specific SCS with the first SCS, the second bandwidth, and the first frequency domain is shown in Table 2. The second bandwidth is nominal channel bandwidth, total bandwidth, system bandwidth, nominal channel bandwidth*80%, total bandwidth*80% or system bandwidth*80%. When the second bandwidth=10 MHz or 8 MHz, 8 MHz is obtained by 10 MHz*80%; when the second bandwidth=20 MHz or 16 MHz, 16 MHz is obtained by 20 MHz*80%; when the second bandwidth=30 MHz or 24 MHz, 24 MHz is obtained by 30 MHz*80%; when the second bandwidth=40 MHz or 32 MHz, 32 MHz is obtained by 40 MHz*80%; when the second bandwidth=80 MHz or 64 MHz, 64 MHz is obtained by 80 MHz*80%; and when the second bandwidth=160 MHz or 128 MHz, 128 is obtained by 160 MHz*80%.

TABLE 2

| | First | First | First | First | First |
|---|---|---|---|---|---|
| | frequency | frequency | frequency | frequency | frequency |
| | domain: FR | domain: | domain: FR | domain: FR 2 | domain: FR |
| | 1 | FR 1 | 1 or FR 2 | or FR 3 | 2 or FR 3 |
| | First SCS: | First SCS: | First SCS: | First SCS: | First SCS: |
| | 15 kHz | 30 kHz | 60 KHz | 120 KHz | 240 kHz |
| Second | 60 KHz | 60 KHz | 60 KHz | / | / |
| bandwidth = 10 | | | | | |
| MHz or 8 MHz | | | | | |
| Second | 120 KHz | 120 KHz | 120 KHz | / | / |
| bandwidth = 20 | | | | | |
| MHz or 16 | | | | | |
| MHZ | | | | | |
| Second | 240 KHz | 240 kHz | 240 KHz | / | / |
| bandwidth = 30 | | | | | |
| MHz or 24 | | | | | |
| MHZ | | | | | |
| Second | 240 kHz | 240 KHz | 240 KHz | / | / |
| bandwidth = 40 | | | | | |
| MHz or 32 | | | | | |
| MHz | | | | | |
| Second | 480 kHz | 480 KHz | 480 KHz | 480 kHz | 480 kHz |
| bandwidth = 80 | | | | | |
| MHz or 64 | | | | | |
| MHZ | | | | | |
| Second | / | / | / | 960 kHz | 960 KHz |
| bandwidth = 160 | | | | | |
| MHz or 128 | | | | | |
| MHz | | | | | |

For example, as shown in Table 2, when the first frequency domain is FR 1 and/or the first SCS is 15 kHz, and the second bandwidth is 2 MHz, the specific SCS is 120 kHz; and when the first frequency domain is FR 1 and/or the first SCS is 30 kHz, and the second bandwidth is 10 MHz, the specific SCS is 60 kHz.

In Item 3, possible values of X are shown in Table 3. Table 4, Table 5 and Table 6, where Table 5 is for rounding up values in Table 4, and Table 6 is for rounding down values in Table 4.

TABLE 3

| SCS (kHz) of | | | | | | |
|---|---|---|---|---|---|---|
| the first SCS | Band- | Band- | Band- | Band- | Band- | Band- |
| or specific | width | width | width | width | width | width |
| SCS or first | 10 | 20 | 40 | 60 | 80 | 100 |
| SL | MHz | MHz | MHz | MHz | MHz | MHz |
| information | X | X | X | X | X | X |
| 15 | 52 | 106 | 216 | / | / | / |
| 30 | 24 | 51 | 106 | 162 | 217 | 273 |
| 60 | 11 | 24 | 51 | 79 | 107 | 135 |

For example, as shown in Table 3, when the SCS of the first SCS or the specific SCS or the first SL information is 15 kHz, and the bandwidth is 10 MHz, the value of X is 52 when the SCS of the first SCS or the specific SCS or the first information is 15 kHz, and the bandwidth is 20 MHz, the value of X is 106 and when the SCS of the first SCS or the specific SCS or the first information is 30 kHz, and the bandwidth is 10 MHz, the value of X is 24.

TABLE 4

| SCS (kHz) | | | | | | |
|---|---|---|---|---|---|---|
| of the first | | | | | | |
| SCS or | Band- | Band- | Band- | Band- | Band- | Band- |
| specific | width | width | width | width | width | width |
| SCS or first | 10 | 20 | 40 | 60 | 80 | 100 |
| SL | MHz | MHz | MHz | MHz | MHz | MHz |
| information | X | X | X | X | X | X |
| 15 | Rounding | Rounding | Rounding | | | |
| | up or | up or | up or | | | |
| | rounding | rounding | rounding | | | |
| | down of | down of | down of | | | |
| | 52*0.8 | 106*0.8 | 216*0.8 | | | |
| 30 | Rounding | Rounding | Rounding | Rounding | Rounding | Rounding |
| | up or | up or | up or | up or | up or | up or |
| | rounding | rounding | rounding | rounding | rounding | rounding |
| | down of | down of | down of | down of | down of | down of |
| | 24*0.8 | 51*0.8 | 106*0.8 | 162*0.8 | 217*0.8 | 273*0.8 |
| 60 | Rounding | Rounding | Rounding | Rounding | Rounding | Rounding |
| | up or | up or | up or | up or | up or | up or |
| | rounding | rounding | rounding | rounding | rounding | rounding |
| | down of | down of | down of | down of | down of | down of |
| | 11*0.8 | 24*0.8 | 51*0.8 | 79*0.8 | 107*0.8 | 135*0.8 |

For example, as shown in Table 4, when the SCS of the first SCS or the specific SCS or the first SL information is 15 kHz, and the bandwidth is 10 MHz, the value of X is rounding up or rounding down of 52*0.8; when the SCS of the first SCS or the specific SCS or the first information is 15 kHz, and the bandwidth is 20 MHz, the value of X is rounding up or rounding down of 106*0.8, and when the SCS of the first SCS or the specific SCS or the first information is 30 kHz, and the bandwidth is 10 MHz, the value of X is rounding up or rounding down of 24*0.8.

TABLE 5

| SCS (KHz) | | | | | | |
|---|---|---|---|---|---|---|
| of the first | | | | | | |
| SCS or | Band- | Band- | Band- | Band- | Band- | Band- |
| specific | width | width | width | width | width | width |
| SCS or first | 10 | 20 | 40 | 60 | 80 | 100 |
| SL | MHz | MHz | MHz | MHz | MHz | MHz |
| information | X | X | X | X | X | X |
| 15 | 42 | 85 | 173 | / | / | / |
| 30 | 20 | 41 | 85 | 130 | 174 | 219 |
| 60 | 9 | 20 | 41 | 64 | 86 | 108 |

For example, as shown in Table 5, when the SCS of the first SCS or the specific SCS or the first SL information is 15 kHz and the bandwidth is 10 MHz, the value of X is rounding up of 52*0.8; when the SCS of the first SCS or the specific SCS or the first information is 15 kHz, and the bandwidth is 20 MHz; the value of X is rounding up of 100*0.8; and when the SCS of the first SCS or the specific SCS or the first information is 30 kHz, and the bandwidth is 10 MHz, the value of X is rounding up of 24*0.8.

TABLE 6

| SCS (kHz) | | | | | | |
|---|---|---|---|---|---|---|
| of the first | | | | | | |
| SCS or | Band- | Band- | Band- | Band- | Band- | Band- |
| specific | width | width | width | width | width | width |
| SCS or first | 10 | 20 | 40 | 60 | 80 | 100 |
| SL | MHz | MHz | MHz | MHz | MHz | MHz |
| information | X | X | X | X | X | X |
| 15 | 41 | 84 | 172 | / | / | / |
| 30 | 19 | 40 | 84 | 129 | 173 | 218 |
| 60 | 8 | 19 | 40 | 63 | 85 | 108 |

For example, as shown in Table 6, when the SCS of the first SCS or the specific SCS or the first SL information is 15 kHz, and the bandwidth is 10 MHz, the value of X is rounding down of 52*0.8; when the SCS of the first SCS or the specific SCS or the first information is 15 kHz, and the bandwidth is 20 MHz, the value of X is rounding down of 100*0.8; and when the SCS of the first SCS or the specific SCS or the first information is 30 kHz, and the bandwidth is 10 MHz, the value of X is rounding down of 24*0.8.

In some embodiments, in Item 3, the interlace includes J second frequency domain resources, each second frequency domain resource includes at least two frequency domain resource unit groups, and a frequency domain interval between two adjacent frequency domain resource units is K first frequency domain resources; and each frequency domain resource unit group includes at least one frequency domain resource unit, where

each first frequency domain resource or each second frequency domain resource includes at least one frequency domain resource unit, K≥1, and J≥1.

Each first frequency domain resource or second frequency domain resource includes at least one frequency domain resource unit, for example, the interlace is 11 second frequency domain resources, and an interval between two adjacent frequency domain resource units in a frequency domain resource unit group in each second frequency domain resource is 5 RB, and each second frequency domain resource includes one RB.

In some embodiments, values of K and J are as follows:
K≤first preset value*first bandwidth+1; and J=first bandwidth/K, or J=first bandwidth*second preset value/K, where
both the first preset value and the second preset value are related to the OCB, and in some embodiments, the first preset value=1-second preset value, for example, the first preset value=10%, and the second preset value=80%. If the first bandwidth/K or the second preset value cannot be evenly divided by K, rounding up or rounding down can be used.

Herein, the first SL information is transmitted by using the interlace, occupying at least one interlace in the frequency domain, and a frequency domain span of the occupied interlace can meet the OCB requirement.

As for Item 4: first SL information within a first preset time, at least one first transmission exists within the first preset time, and the first transmission meets the OCB requirement.

In some embodiments, the first preset time is a sweep time, such as 1 s.

Herein, there is at least one first transmission and at least one piece of first SL information within one or specific or any preset time, where at least part of the at least one first transmission meets the OCB requirement, thereby ensuring that the first SL information transmitted together with the first transmission meets the OCB requirement.

In some embodiments, the first SL information indicates target information, and the target information includes at least one of the following:
a quantity of pieces of first SL information (in FDM),
a quantity of repetitions of first SL information;
a number of first SL information, for example, a number of a plurality of pieces of first SL information in FDM;
an interlace of first SL information;
an SCS of first SL information such as whether it is a specific SCS;
a sequence of first SL information such as whether it is a first sequence;
frequency domain bandwidth of first SL information such as whether it is a specific frequency domain;
a multiplexing manner of first SL information such as whether it is a specific multiplexing manner;
information about a broadcast channel associated with the first SL information;
information about a synchronization signal, a broadcast channel, or a synchronization signal block other than the first SL information, and the information herein includes at least one of a position, a number, an interval, a sub-carrier space, a sequence, bandwidth, a quantity of resource units, or an interlace;
information about associated second information, the second information herein can be information about other signals or channels other than the first SL information, and the information herein includes at least one of a position, a number, an interval, a sub-carrier space, a sequence, bandwidth, a quantity of resource units, or an interlace;
information about a first preset time;
information about associated first transmission, such as a quantity of, a position, an interval, a sub-carrier space, a sequence, an interlace, a number, bandwidth, or a quantity of resource units of the first transmission;
information about associated bandwidth; or
information about an associated channel, including information about an associated nominal channel and/or information about an associated broadcast channel, and the information includes a quantity, a position, an interval, bandwidth, a quantity of resource units, and the like.

In some embodiments, if there are a plurality of pieces of first SL information in FDM, at least one piece of first SL information indicates the target information.

In some embodiments, the first SL information indicates target information by using at least one of the following:
a synchronization signal sequence, that is, different first SL information corresponds to different target information;
a broadcast channel, such as indicating the target information through a primary information block in the broadcast channel, that is, carrying the target information in the primary information block in the broadcast channel;
a reference signal sequence, that is, different reference signals (such as DMRS) are corresponding to different target information; or
scrambling information or descrambling information of the first SL information, where the scrambling information or the descrambling information is obtained based on part of the target information. Herein, scrambling is performed based on at least part of the target information, so that different reference signal sequences are corresponding to different scrambling, and the target information is indicated by scrambling or descrambling.

The first SL information indicates the target information through at least one of the above items, which can help the UE to quickly find other synchronization signals after receiving one synchronization signal and merge them, thus speeding up a synchronization process.

According to the method in this embodiment of this application, the resource of the first information is sensed on the unlicensed band or the shared band, and/or the first information is transmitted, where the first information is SL information meeting the specific condition, for example, N1 pieces of first SL information in FDM, and for example, the first SL information based on the first parameter; for another example, the first SL information within the first preset time, where at least one first transmission exists within the first preset time; and N pieces of first information in FDM. The first information meeting the specific condition can meet the first transmission requirement by itself, or the first information can be SL information transmitted together with the first transmission meeting the first transmission requirement, so that the first transmission requirement can be met when the first information meeting the specific condition is transmitted on the unlicensed band or the shared band, such as meeting the OCB requirement.

As shown in FIG. 7, an embodiment of this application further provides an information indication method, including the following steps.

Step 701: A network side device instructs a terminal to sense a resource of first information on an unlicensed band or a shared band, and/or perform a transmission of first information.

The first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2≥1;
first SL information based on a first parameter; or
first SL information within a first preset time, where at least one first transmission exists within the first preset time, where
the first SL information includes a synchronization signal, a broadcast channel, or a synchronization signal block.

In this embodiment of this application, the terminal is instructed to sense the resource of the first information on the unlicensed band or the shared band, and/or perform a transmission of the first information, where the first information is SL information meeting the specific condition, for example, N1 pieces of first SL information in FDM, and for example, the first SL information based on the first parameter; for another example, the first SL information within the first preset time, where at least one first transmission exists within the first preset time; and N pieces of first information in FDM. The first information meeting the specific condition can meet the first transmission requirement by itself, or the first information can be SL information transmitted together with the first transmission meeting the first transmission requirement, so that the first transmission requirement can be met when the first information meeting the specific condition is transmitted on the unlicensed band or the shared band, such as meeting the OCB requirement.

The method in this embodiment of this application further includes:
configuring third information and sending the third information to the terminal, where
the third information includes at least one of the following:
N1;
G1, where G1 is a frequency domain interval between any adjacent first SL information or specific adjacent first SL information in the N1 pieces of first SL information;
a frequency domain position of first SL information;
a number of first SL information;
N;
N2;
G2, where G2 is a frequency domain interval between any adjacent first information or specific adjacent first information in the N pieces of first information;
a frequency domain position of second information;
a type of second information;
bandwidth of second information;
a number of second information;
a structure of second information:
a first parameter: or
indication information, where the indication information is used to indicate whether a transmission of the first SL information is based on the first parameter.

In some embodiments, the first information meets a first transmission requirement, and/or the first transmission meets the first transmission requirement.

Herein, the first information is first information that meets a specific condition, for example, the first information itself meets the first transmission requirement, or the first information and the first transmission meeting the first transmission requirement are jointly transmitted within a first preset time. In addition, it should be noted that the synchronization signal and the broadcast information may meet same or different conditions. For example, the synchronization signal is a synchronization signal transmitted based on the first parameter, and the broadcast information is broadcast information within the first preset time.

In addition, the N1 pieces of first SL information in frequency division multiplexing may also be described as time domain overlap of the N1 pieces of first SL information; and the N pieces of first information in FDM may also be described as time domain overlap of the N pieces of first information.

In some embodiments, the first transmission requirement may be OCB, and may also be another transmission requirement. In the following, this application takes OCB as the first transmission requirement as an example for illustration. The OCB refers to that in an unlicensed band, when a device transmits a signal in an occupied resource, it needs to be ensured that within one nominal channel bandwidth (for example, 20 MHz or 10 MHz, and bandwidths are different in different countries and regions), 99% frequency domain span of power distribution is not less than 80% of the nominal channel bandwidth.

In some embodiments, the first parameter includes at least one of the following:
a specific SCS;
a specific cyclic prefix (CP);
a first SL sequence;
a specific frequency domain, where the specific frequency domain includes X frequency domain resource units, and X is an integer;
a specific multiplexing manner, where the specific multiplexing manner is frequency division multiplexing of a synchronization signal and a broadcast channel, or
an interlace.

In some embodiments, the first parameter is corresponding to at least one of the following:
a first SCS;
second bandwidth; or
a first frequency domain, where
the first SCS is an SCS of an object associated with the first SL information, the object associated with the first SL information is SL data, a control channel, and/or a feedback channel associated with the first SL information, or the object associated with the first SL information is a carrier, a cell, a BWP, an SL resource pool, or a subchannel associated with the first SL information; and
the second bandwidth is bandwidth associated with the first SL information.

In some embodiments, the specific SCS is different from the first SCS, a time unit corresponding to the first SCS includes W pieces of first SL information or W candidate positions of the first SL information, and W≥1.

In some embodiments, when W=1, duration corresponding to the first SL information or duration corresponding to the candidate position of the first SL information is duration of the time unit corresponding to the first SCS, or duration corresponding to the first SL information or duration corresponding to the candidate position of the first SL information is equal to duration of the time unit corresponding to the first SCS obtained after removing at least one of first duration or second duration, where

the first duration includes duration required for at least one of automatic gain control (AGC) or power adjustment, and the second duration includes duration required for at least one of a guard period (GP), radio frequency (RF) adjustment, or receive/transmit transition.

In some embodiments, when W>1, a time interval between any adjacent pieces of first SL information or candidate positions of the first SL information or between specific two adjacent pieces of first SL information or candidate positions of the first SL information in the time unit corresponding to the first SCS is 0 or Z, where Z includes duration required for at least one of first duration or second duration, where

the first duration includes duration required for at least one of automatic gain control (AGC) or power adjustment, and the second duration includes duration required for at least one of a guard period (GP), RF adjustment, or receive/transmit transition.

In some embodiments, if the specific SCS is different from the first SCS, a time corresponding to a target subunit in a time unit in which the first SL information or the candidate position of the first SL information is located is equal to or less than a time corresponding to a target subunit in a time unit corresponding to the first SCS, the target subunit includes at least one of first duration or second duration, the first duration includes duration required for at least one of automatic gain control (AGC) or power adjustment, and the second duration includes duration required for at least one of a guard period (GP), RF adjustment, or receive/transmit transition.

In some embodiments, the interlace includes J second frequency domain resources, each second frequency domain resource includes at least two frequency domain resource unit groups, and a frequency domain interval between two adjacent frequency domain resource units is K first frequency domain resources, where

each first frequency domain resource or each second frequency domain resource includes at least one frequency domain resource unit, K≥1, and J≥1.

It should be noted that the first parameter in this embodiment of this application is the same as the first parameter in the method embodiment of the terminal side, and details are not described herein again.

In some embodiments, the first SL information indicates target information, and the target information includes at least one of the following:
a quantity of pieces of first SL information;
a quantity of repetitions of first SL information;
a number of first SL information;
an interlace of first SL information;
an SCS of first SL information;
a sequence of first SL information;
frequency domain bandwidth of first SL information;
a multiplexing manner of first SL information;
information about a synchronization signal, a broadcast channel, or a synchronization signal block other than the first SL information;
information about associated second information:
information about a first preset time;
information about associated first transmission;
information about associated bandwidth; or
information about an associated channel.

In some embodiments, the second information includes at least one of the following:
a physical sidelink control channel (PSCCH);
a physical sidelink shared channel (PSSCH);
a physical sidelink feedback channel (PSFCH);
a reference signal (RS);
an LTE SL signal;
a redundant sequence or a redundant message;
a frequency domain interval between any adjacent first information or specific adjacent first information; or
a channel of Uu, a signal of Uu, or transmission of Uu.

In some embodiments, the first SL information indicates target information by using at least one of the following:
a synchronization signal sequence;
a broadcast channel:
a reference signal sequence; or
scrambling information or descrambling information of the first SL information, where the scrambling information or the descrambling information is obtained based on part of the target information.

In this embodiment of this application, the terminal is instructed to sense the resource of the first information on the unlicensed band or the shared band, and/or perform a transmission of the first information, where the first information is SL information meeting the specific condition, for example, N1 pieces of first SL information in FDM, and for example, the first SL information based on the first parameter; for another example, the first SL information within the first preset time, where at least one first transmission exists within the first preset time; and N pieces of first information in FDM. The first information meeting the specific condition can meet the first transmission requirement by itself, or the first information can be SL information transmitted together with the first transmission meeting the first transmission requirement, so that the first transmission requirement can be met when the first information meeting the specific condition is transmitted on the unlicensed band or the shared band, such as meeting the OCB requirement.

It should be noted that the information transmission method provided in this embodiment of this application may be performed by an information transmission apparatus, or a control module that is in the information transmission apparatus and that is configured to perform the information transmission method. In this embodiment of this application, that the information transmission apparatus performs the information transmission method is used as an example to describe the information transmission apparatus provided in this embodiment of this application.

As shown in FIG. 8, an embodiment of this application further provides an information transmission apparatus 800, including:
a first processing module 801, configured to: sense a resource of first information on an unlicensed band or a shared band, and/or perform a transmission of first information, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2≥1;
first SL information based on a first parameter; or
first SL information within a first preset time, where at least one first transmission exists within the first preset time, where
the first SL information includes a synchronization signal, a broadcast channel, or a synchronization signal block.

The apparatus in this embodiment of this application further includes:

a determining module, configured to determine first information.

In some embodiments, the first information meets a first transmission requirement.

In some embodiments, the first transmission meets a first transmission requirement.

The apparatus in this embodiment of this application further includes;
a first obtaining module, configured to obtain at least one item of third information through a first obtaining manner, where
the third information includes at least one of the following:
N1;
G1, where G1 is a frequency domain interval between any adjacent first SL information or specific adjacent first SL information in the N1 pieces of first SL information;
a frequency domain position of first SL information;
a number of first SL information;
N;
N2;
G2, where G2 is a frequency domain interval between any adjacent first information or specific adjacent first information in the N pieces of first information;
a frequency domain position of second information;
a type of second information;
bandwidth of second information;
a number of second information;
a structure of second information;
a first parameter; or
indication information, where the indication information is used to indicate whether a transmission of the first SL information is based on the first parameter, where
the first obtaining manner includes at least one of the following:
being configured by a control node;
being determined by the terminal;
being preconfigured;
being predefined, or
being indicated by another terminal.

In some embodiments, the first obtaining module is configured to determine G1 based on first bandwidth and N1, where the first bandwidth is bandwidth associated with the first SL information.

In some embodiments, G1 determined by being configured, preconfigured, or predefined by a control node is greater than or equal to a first preset value.

In some embodiments, the first obtaining module determines G1 by using at least one of the following formulas:

G1=(first bandwidth÷N1);

G1=floor(first bandwidth÷N1), where floor is rounded down; or

G1=ceil(first bandwidth÷N1), where ceil is rounded up.

In some embodiments, N1 pieces of first SL information are N1 pieces of same first SL information: or

at least M pieces of first SL information among N1 pieces of first SL information are at least partially different, where M>1.

In some embodiments, the first parameter includes at least one of the following:
a specific SCS;
a specific cyclic prefix (CP);
a first SL sequence;
a specific frequency domain, where the specific frequency domain includes X frequency domain resource units, and X is an integer;
a specific multiplexing manner, where the specific multiplexing manner is frequency division multiplexing of a synchronization signal and a broadcast channel; or
an interlace.

In some embodiments, the first processing module is configured to perform a transmission of the first SL information based on the first parameter when it is satisfied that an SCS of an object associated with the first SL information is a first SCS, bandwidth associated with the first SL information is second bandwidth, and a frequency domain associated with the first SL information is at least one item of a first frequency domain, where

the object associated with the first SL information is SL data, a control channel, and/or a feedback channel associated with the first SL information, or the object associated with the first SL information is a carrier, a cell, a BWP, an SL resource pool, or a subchannel associated with the first SL information.

In some embodiments, a time unit corresponding to the first SCS includes W pieces of first SL information or W candidate positions of the first SL information, and W≥1.

In some embodiments, when W=1, duration corresponding to the first SL information or duration corresponding to the candidate position of the first SL information is duration of the time unit corresponding to the first SCS, or duration corresponding to the first SL information or duration corresponding to the candidate position of the first SL information is equal to duration of the time unit corresponding to the first SCS obtained after removing at least one of first duration or second duration, where

the first duration includes duration required for at least one of automatic gain control (AGC) or power adjustment, and the second duration includes duration required for at least one of a guard period (GP), radio frequency (RF) adjustment, or receive/transmit transition.

In some embodiments, when W>1, a time interval between any adjacent pieces of first SL information or candidate positions of the first SL information or between specific two adjacent pieces of first SL information or candidate positions of the first SL information in the time unit corresponding to the first SCS is 0 or Z, where Z includes duration required for at least one of first duration or second duration, where

the first duration includes duration required for at least one of automatic gain control (AGC) or power adjustment, and the second duration includes duration required for at least one of a guard period (GP), RF adjustment, or receive/transmit transition.

In some embodiments, a time corresponding to a target subunit in a time unit in which the first SL information or the candidate position of the first SL information is located is equal to or less than a time corresponding to a target subunit in a time unit corresponding to the first SCS, the target subunit includes at least one of first duration or second duration, the first duration includes duration required for at least one of automatic gain control (AGC) or power adjustment, and the second duration includes duration required for at least one of a guard period (GP), RF adjustment, or receive/transmit transition.

In some embodiments, the interlace includes J second frequency domain resources, each second frequency domain resource includes at least two frequency domain resource unit groups, and a frequency domain interval between two adjacent frequency domain resource units is K first frequency domain resources, where

each first frequency domain resource or each second frequency domain resource includes at least one frequency domain resource unit, K≥1, and J≥1.

In some embodiments, the first SL information indicates target information, and the target information includes at least one of the following:
a quantity of pieces of first SL information;
a quantity of repetitions of first SL information;
a number of first SL information;
an interlace of first SL information;
an SCS of first SL information;
a sequence of first SL information;
frequency domain bandwidth of first SL information;
a multiplexing manner of first SL information;
information about a synchronization signal, a broadcast channel, or a synchronization signal block other than the first SL information;
information about associated second information;
information about a first preset time;
information about associated first transmission;
information about associated bandwidth; or
information about an associated channel.

In some embodiments, the second information includes at least one of the following:
a physical sidelink control channel (PSCCH);
a physical sidelink shared channel (PSSCH);
a physical sidelink feedback channel (PSFCH);
a reference signal (RS);
an LTE SL signal;
a redundant sequence or a redundant message;
a frequency domain interval between any adjacent first information or specific adjacent first information; or
a channel of Uu, a signal of Uu, or transmission of Uu.

In some embodiments, the first SL information indicates target information by using at least one of the following:
a synchronization signal sequence;
a broadcast channel;
a reference signal sequence; or
scrambling information or descrambling information of the first SL information, where the scrambling information or the descrambling information is obtained based on part of the target information.

According to the information transmission apparatus in this embodiment of this application, the resource of the first information is sensed on the unlicensed band or the shared band, and/or the first information is transmitted, where the first information is SL information meeting the specific condition, for example, N1 pieces of first SL information in FDM, and for example, the first SL information based on the first parameter; for another example, the first SL information within the first preset time, where at least one first transmission exists within the first preset time; and N pieces of first information in FDM. The first information meeting the specific condition can meet the first transmission requirement by itself, or the first information can be SL information transmitted together with the first transmission meeting the first transmission requirement, so that the first transmission requirement can be met when the first information meeting the specific condition is transmitted on the unlicensed band or the shared band, such as meeting the OCB requirement.

The information transmission apparatus in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include but is not limited to the types of the foregoing listed terminal 11, and the non-mobile terminal may be a server, a Network Attached Storage (NAS), a personal computer (PC), a television (TV), a teller machine, or a self-service machine. This is not specifically limited in this embodiment of this application.

The apparatus provided in this embodiment of this application can implement the processes implemented in the method embodiments from FIG. 2 to FIG. 6, and a same technical effect can be achieved. To avoid repetition, details are not described herein again.

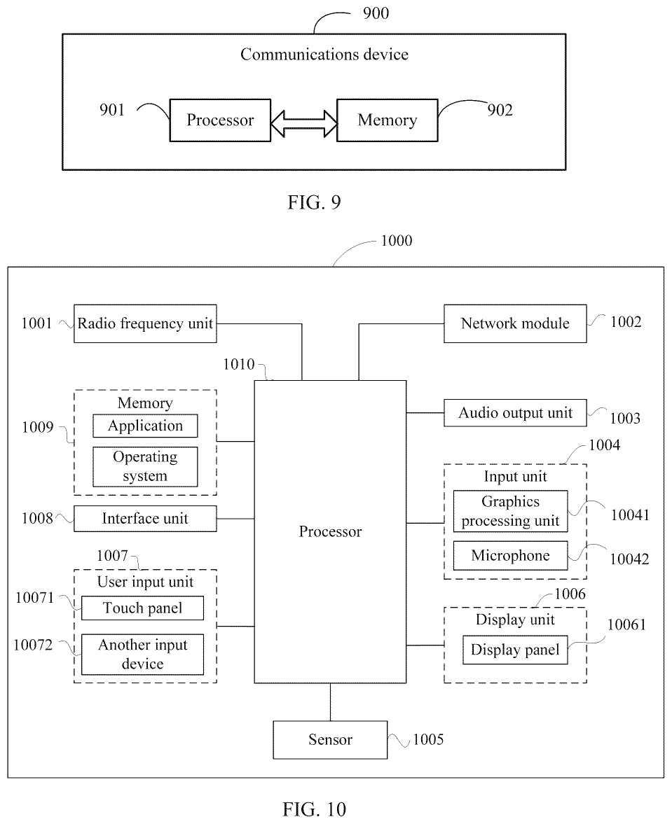

As shown in FIG. 9, an embodiment of this application further provides a communications device 900, including a processor 901, a memory 902, a program or an instruction stored in the memory 902 and executable on the processor 901. For example, when the communications device 900 is a terminal, the program or the instruction is executed by the processor 901 to implement processes of the embodiment of the foregoing information transmission method applied to the terminal, and a same technical effect can be achieved. When the communications device 900 is a network side device, the program or the instruction, when executed by the processor 901, implements processes of the embodiment of the foregoing information indication method applied to the network side device, and a same technical effect can be achieved. To avoid repetition, details are not described herein again.

An embodiment of this application further provides a terminal, including a processor and a communications interface, where the processor is configured to sense a resource of first information on an unlicensed band or a shared band, and/or the communications interface is configured to perform a transmission of first information on an unlicensed band or a shared band, where the first information includes at least one of the following:

N1 pieces of first SL information in frequency division multiplexing (FDM), where N1>1:

N pieces of first information in FDM, where the N pieces of first information include N2 pieces of first SL information and N−N2 pieces of second information, N>1, and N2>L;
first SL information based on a first parameter; or
first SL information within a first preset time, where at least one first transmission exists within the first preset time, where
the first SL information includes a synchronization signal, a broadcast channel, or a synchronization signal block.

This terminal embodiment corresponds to the foregoing method embodiment on the terminal side. Each implementation process and implementation of the foregoing method embodiment may be applicable to this terminal embodiment, and a same technical effect can be achieved. FIG. 10 is a schematic diagram of a hardware structure of a terminal for implementing embodiments of this application. The terminal 1000 includes but is not limited to at least part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that, in this embodiment of this application, the input unit 1004 may include a Graphics Processing Unit (GPU) 10041 and a microphone 10042, and the graphics processing unit 10041 processes image data of a still picture or a video obtained by an image capture apparatus (such as a camera) in a video capture mode or an image capture mode. The display unit 1006 may include a display panel 10061. In some embodiments, the display panel 10061 may be configured in a form such as a liquid crystal display or an organic light-emitting diode. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, the radio frequency unit 1001 receives downlink data from a network side device and then sends the downlink data to the processor 1010 for processing; and sends uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a program or instruction storage area and a data storage area. The program or instruction storage area may store an operating system, and an application or an instruction required by at least one function (for example, a sound playing function or an image playing function). In addition, the memory 1009 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 1010 may include one or more processing units. In some embodiments, an application processor and a modem processor may be integrated into the processor 1010. The application processor mainly processes an operating system, a user interface, an application, an instruction, or the like. The modem processor mainly processes wireless communication, for example, a baseband processor. It can be understood that the modem processor may not be integrated into the processor 1010.

The processor 1010 is configured to sense a resource of first information on an unlicensed band or a shared band, and/or the radio frequency unit 1001 is configured to perform a transmission of first information on an unlicensed band or a shared band, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2>1;
first SL information based on a first parameter; or
first SL information within a first preset time, where at least one first transmission exists within the first preset time, where
the first SL information includes a synchronization signal, a broadcast channel, or a synchronization signal block.

In some embodiments, the first information meets a first transmission requirement.

In some embodiments, the first transmission meets a first transmission requirement.

In some embodiments, the processor 1010 is configured to obtain at least one item of third information through a first obtaining manner, where
the third information includes at least one of the following:
N1;
G1, where G1 is a frequency domain interval between any adjacent first SL information or specific adjacent first SL information in the N1 pieces of first SL information;
a frequency domain position of first SL information;
a number of first SL information;
N;
N2;
G2, where G2 is a frequency domain interval between any adjacent first information or specific adjacent first information in the N pieces of first information;
a frequency domain position of second information:
a type of second information;
bandwidth of second information;
a number of second information;
a structure of second information;
a first parameter; or
indication information, where the indication information is used to indicate whether a transmission of the first SL information is based on the first parameter, where
the first obtaining manner includes at least one of the following:
being configured by a control node;
being determined by the terminal;
being preconfigured;
being predefined, or
being indicated by another terminal.

In some embodiments, the processor 1010 is configured to determine G1 based on first bandwidth and N1, where the first bandwidth is bandwidth associated with the first SL information.

In some embodiments, G1 determined by being configured, preconfigured, or predefined by a control node is greater than or equal to a first preset value.

In some embodiments, the processor 1010 is configured to determine G1 by using at least one of the following formulas:

G1=(first bandwidth÷N1);

G1=floor(first bandwidth÷N1), where floor is rounded down; or

G1=ceil(first bandwidth÷N1), where ceil is rounded up.

In some embodiments, N1 pieces of first SL information are N1 pieces of same first SL information; or
at least M pieces of first SL information among N1 pieces of first SL information are at least partially different, where M>1.

In some embodiments, the first parameter includes at least one of the following:
a specific SCS;
a specific cyclic prefix (CP);
a first SL sequence;
a specific frequency domain, where the specific frequency domain includes X frequency domain resource units, and X is an integer;
a specific multiplexing manner, where the specific multiplexing manner is frequency division multiplexing of a synchronization signal and a broadcast channel; or
an interlace.

In some embodiments, the radio frequency unit 1001 is further configured to:
perform a transmission of the first SL information based on the first parameter when it is satisfied that an SCS of an object associated with the first SL information is a first SCS, bandwidth associated with the first SL information is second bandwidth, and a frequency domain associated with the first SL information is at least one item of a first frequency domain, where
the object associated with the first SL information is SL data, a control channel, and/or a feedback channel associated with the first SL information, or the object associated with the first SL information is a carrier, a cell, a BWP, an SL resource pool, or a subchannel associated with the first SL information.

In some embodiments, a time unit corresponding to the first SCS includes W pieces of first SL information or W candidate positions of the first SL information, and W≥1.

In some embodiments, when W=1, duration corresponding to the first SL information or duration corresponding to the candidate position of the first SL information is duration of the time unit corresponding to the first SCS, or duration corresponding to the first SL information or duration corresponding to the candidate position of the first SL information is equal to duration of the time unit corresponding to the first SCS obtained after removing at least one of first duration or second duration, where the first duration includes duration required for at least one of automatic gain control (AGC) or power adjustment, and the second duration includes duration required for at least one of a guard period (GP), radio frequency (RF) adjustment, or receive/transmit transition.

In some embodiments, when W>1, a time interval between any adjacent pieces of first SL information or candidate positions of the first SL information or between specific two adjacent pieces of first SL information or candidate positions of the first SL information in the time unit corresponding to the first SCS is 0 or Z, where Z includes duration required for at least one of first duration or second duration, where

the first duration includes duration required for at least one of automatic gain control (AGC) or power adjustment, and the second duration includes duration required for at least one of a guard period (GP), RF adjustment, or receive/transmit transition.

In some embodiments, a time corresponding to a target subunit in a time unit in which the first SL information or the candidate position of the first SL information is located is equal to or less than a time corresponding to a target subunit in a time unit corresponding to the first SCS, the target subunit includes at least one of first duration or second duration, the first duration includes duration required for at least one of automatic gain control (AGC) or power adjustment, and the second duration includes duration required for at least one of a guard period (GP), RF adjustment, or receive/transmit transition.

In some embodiments, the interlace includes J second frequency domain resources, each second frequency domain resource includes at least two frequency domain resource unit groups, and a frequency domain interval between two adjacent frequency domain resource units is K first frequency domain resources, where

each first frequency domain resource or each second frequency domain resource includes at least one frequency domain resource unit, K≥1, and J≥1.

In some embodiments, the first SL information indicates target information, and the target information includes at least one of the following:
a quantity of pieces of first SL information;
a quantity of repetitions of first SL information;
a number of first SL information;
an interlace of first SL information;
an SCS of first SL information;
a sequence of first SL information;
frequency domain bandwidth of first SL information;
a multiplexing manner of first SL information;
information about a synchronization signal, a broadcast channel, or a synchronization signal block other than the first SL information;
information about associated second information;
information about a first preset time;
information about associated first transmission;
information about associated bandwidth; or
information about an associated channel.

In some embodiments, the second information includes at least one of the following:
a physical sidelink control channel (PSCCH);
a physical sidelink shared channel (PSSCH);
a physical sidelink feedback channel (PSFCH);
a reference signal (RS);
an LTE SL signal;
a redundant sequence or a redundant message,
a frequency domain interval between any adjacent first information or specific adjacent first information; or
a channel of Uu, a signal of Uu, or transmission of Uu.

In some embodiments, the first SL information indicates target information by using at least one of the following:
a synchronization signal sequence:
a broadcast channel,
a reference signal sequence, or
scrambling information or descrambling information of the first SL information, where the scrambling information or the descrambling information is obtained based on part of the target information.

According to the terminal in this embodiment of this application, the resource of the first information is sensed on the unlicensed band or the shared band, and/or the first information is transmitted, where the first information is SL information meeting the specific condition, for example, N1 pieces of first SL information in FDM, and for example, the first SL information based on the first parameter: for another example, the first SL information within the first preset time, where at least one first transmission exists within the first preset time; and N pieces of first information in FDM. The first information meeting the specific condition can meet the first transmission requirement by itself, or the first information can be SL information transmitted together with the first transmission meeting the first transmission requirement, so that the first transmission requirement can be met when the first information meeting the specific condition is transmitted on the unlicensed band or the shared band, such as meeting the OCB requirement.

It should be noted that the information indication method provided in the embodiments of this application can be performed by an information indication apparatus or a control module included in the information indication apparatus and configured to execute the information indication method. In an embodiment of this application, the information indication apparatus provided in the embodiments of the application is described by using an example in which the information indication method is performed by an information indication apparatus.

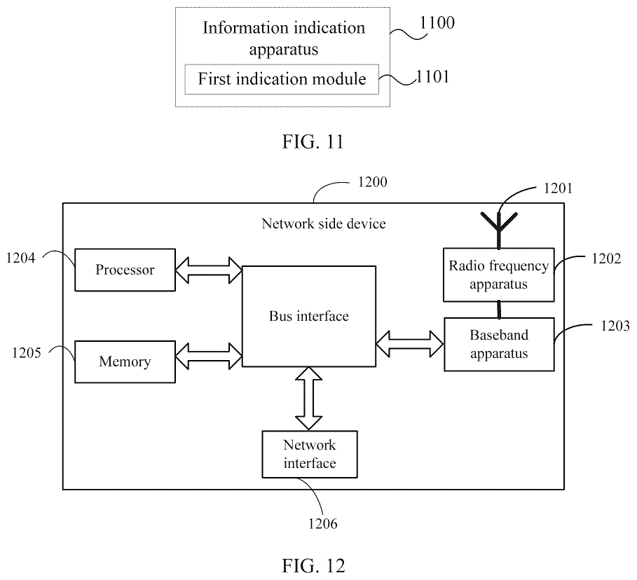

As shown in FIG. 11, an embodiment of this application further provides an information indication apparatus 1100, including:
a first indication module 1101, configured to: instruct a terminal to sense a resource of first information on an unlicensed band or a shared band, and/or perform a transmission of first information, where
the first information includes at least one of the following:
N1 pieces of first SL information in frequency division multiplexing (FDM), where N1>1;
N pieces of first information in FDM, where the N pieces of first information include N2 pieces of first SL information and N−N2 pieces of second information, N>1, and N2≥1;
first SL information based on a first parameter; or
first SL information within a first preset time, where at least one first transmission exists within the first preset time, where
the first SL information includes a synchronization signal, a broadcast channel, or a synchronization signal block.

The apparatus in this embodiment of this application further includes a second determining module, configured to determine first information.

The apparatus in this embodiment of this application further includes:
a second processing module, configured to: configure third information and send the third information to the terminal, where
the third information includes at least one of the following:
N1;
G1, where G1 is a frequency domain interval between any adjacent first SL information or specific adjacent first SL information in the N1 pieces of first SL information;
a frequency domain position of first SL information;
a number of first SL information;
N;
N2;
G2, where G2 is a frequency domain interval between any adjacent first information or specific adjacent first information in the N pieces of first information;
a frequency domain position of second information;
a type of second information;
bandwidth of second information;
a number of second information;
a structure of second information;
a first parameter; or
indication information, where the indication information is used to indicate whether a transmission of the first SL information is based on the first parameter.

In some embodiments, the first information meets a first transmission requirement.

In some embodiments, the first transmission meets a first transmission requirement.

In some embodiments, the first parameter includes at least one of the following:
a specific SCS;
a specific cyclic prefix (CP);
a first SL sequence;
a specific frequency domain, where the specific frequency domain includes X frequency domain resource units, and X is an integer;
a specific multiplexing manner, where the specific multiplexing manner is frequency division multiplexing of a synchronization signal and a broadcast channel; or
an interlace.

In some embodiments, the first parameter is corresponding to at least one of the following:
a first SCS;
second bandwidth; or
a first frequency domain, where
the first SCS is an SCS of an object associated with the first SL information, the object associated with the first SL information is SL data, a control channel, and/or a feedback channel associated with the first SL information, or the object associated with the first SL information is a carrier, a cell, a BWP, an SL resource pool, or a subchannel associated with the first SL information; and
the second bandwidth is bandwidth associated with the first SL information.

In some embodiments, a time unit corresponding to the first SCS includes W pieces of first SL information or W candidate positions of the first SL information, and W≥1.

In some embodiments, when W=1, duration corresponding to the first SL information or duration corresponding to the candidate position of the first SL information is duration of the time unit corresponding to the first SCS, or duration corresponding to the first SL information or duration corresponding to the candidate position of the first SL information is equal to duration of the time unit corresponding to the first SCS obtained after removing at least one of first duration and second duration, where

the first duration includes duration required for at least one of automatic gain control (AGC) and power adjustment, and the second duration includes duration required for at least one of a guard period (GP), radio frequency (RF) adjustment, and receive/transmit transition.

In some embodiments, when W<1, a time interval between any adjacent pieces of first SL information or candidate positions of the first SL information or between specific two adjacent pieces of first SL information or candidate positions of the first SL information in the time unit corresponding to the first SCS is 0 or Z, where Z includes duration required for at least one of first duration and second duration, where

the first duration includes duration required for at least one of automatic gain control (AGC) and power adjustment, and the second duration includes duration required for at least one of a guard period (GP), RF adjustment, and receive/transmit transition.

In some embodiments, a time corresponding to a target subunit in a time unit in which the first SL information or the candidate position of the first SL information is located is equal to or less than a time corresponding to a target subunit in a time unit corresponding to the first SCS, the target subunit includes at least one of first duration and second duration, the first duration includes duration required for at least one of automatic gain control (AGC) and power adjustment, and the second duration includes duration required for at least one of a guard period (GP), RF adjustment, and receive/transmit transition.

In some embodiments, the interlace includes J second frequency domain resources, each second frequency domain resource includes at least two frequency domain resource unit groups, and a frequency domain interval between two adjacent frequency domain resource units is K first frequency domain resources, where

each first frequency domain resource or each second frequency domain resource includes at least one frequency domain resource unit, K≥1, and J≥1.

In some embodiments, the first SL information indicates target information, and the target information includes at least one of the following:
a quantity of pieces of first SL information;
a quantity of repetitions of first SL information;
a number of first SL information;
an interlace of first SL information;
an SCS of first SL information;
a sequence of first SL information;
frequency domain bandwidth of first SL information;
a multiplexing manner of first SL information;
information about a synchronization signal, a broadcast channel, or a synchronization signal block other than the first SL information;
information about associated second information;
information about a first preset time;
information about associated first transmission;
information about associated bandwidth; and information about an associated channel.

In some embodiments, the second information includes at least one of the following:
a physical sidelink control channel (PSCCH);
a physical sidelink shared channel (PSSCH);
a physical sidelink feedback channel (PSFCH);
a reference signal (RS);
an LTE SL signal;
a redundant sequence or a redundant message;
a frequency domain interval between any adjacent first information or specific adjacent first information; and
a channel of Uu, a signal of Uu, or transmission of Uu.

In some embodiments, the first SL information indicates target information by using at least one of the following:
a synchronization signal sequence;
a broadcast channel;
a reference signal sequence; and
scrambling information or descrambling information of the first SL information, where the scrambling information or the descrambling information is obtained based on part of the target information.

According to the information indication apparatus in this embodiment of this application, the terminal is instructed to sense the resource of the first information on the unlicensed band or the shared band, and/or perform a transmission of the first information, where the first information is SL information meeting the specific condition, for example, N1 pieces of first SL information in FDM, and for example, the first SL information based on the first parameter; for another example, the first SL information within the first preset time, where at least one first transmission exists within the first preset time; and N pieces of first information in FDM. The first information meeting the specific condition can meet the first transmission requirement by itself, or the first information can be SL information transmitted together with the first transmission meeting the first transmission requirement, so that the first transmission requirement can be met when the first information meeting the specific condition is transmitted on the unlicensed band or the shared band, such as meeting the OCB requirement.

An embodiment of this application further provides a network side device, including a processor and a communications interface, where the processor is configured to instruct a terminal to sense a resource of first information on an unlicensed band or a shared band, and/or perform a transmission of first information, where
the first information includes at least one of the following:
N1 pieces of first SL information in frequency division multiplexing (FDM), where N1>1:
N pieces of first information in FDM, where the N pieces of first information include N2 pieces of first SL information and N−N2 pieces of second information, N>1, and N2≥1;
first SL information based on a first parameter; and
first SL information within a first preset time, where at least one first transmission exists within the first preset time, where
the first SL information includes a synchronization signal, a broadcast channel, or a synchronization signal block.

This network side device embodiment corresponds to the foregoing method embodiment on the network side device. Each implementation process and implementation of the foregoing method embodiment may be applicable to this network side device embodiment, and a same technical effect can be achieved.

An embodiment of this application further provides a network side device. As shown in FIG. 12, the network side device 1200 includes an antenna 1201, a radio frequency apparatus 1202, and a baseband apparatus 1203. The antenna 1201 is connected to the radio frequency apparatus 1202. In an uplink direction, the radio frequency apparatus 1202 receives information by using the antenna 1201, and sends the received information to the baseband apparatus 1203 for processing. In a downlink direction, the baseband apparatus 1203 processes to-be-sent information, and sends the information to the radio frequency apparatus 1202. The radio frequency apparatus 1202 processes the received information and then sends the information by using the antenna 1201.

The frequency band processing apparatus may be located in the baseband apparatus 1203. The method performed by the network side device in the foregoing embodiment may be implemented in the baseband apparatus 1203. The baseband apparatus 1203 includes a processor 1204 and a memory 1205.

The baseband apparatus 1203 may include, for example, at least one baseband board, where a plurality of chips are disposed on the baseband board. As shown in FIG. 12, one chip is, for example, the processor 1204, which is connected to the memory 1205, so as to invoke a program in the memory 1205 to perform operations of the network side device shown in the foregoing method embodiment.

The baseband apparatus 1203 may further include a network interface 1206, configured to exchange information with the radio frequency apparatus 1202. For example, the interface is a common public radio interface (CPRI).

The network side device in this embodiment of the present application further includes an instruction or a program that is stored in the memory 1205 and that can be run on the processor 1204. The processor 1204 invokes the instruction or the program in the memory 1205 to perform the method performed by the modules shown in FIG. 11, and a same technical effect is achieved. To avoid repetition, details are not described herein again.

An embodiment of this application further provides a readable storage medium. The readable storage medium stores a program or an instruction, and when the program or the instruction is executed by a processor, the processes of the embodiment of the foregoing information transmission method or information indication method are implemented and a same technical effect can be achieved. To avoid repetition, details are not described herein again.

The processor is a processor in the terminal in the foregoing embodiment. The readable storage medium includes a computer-readable storage medium, such as a computer Read-Only Memory (ROM), a Random Access Memory (RAM), a magnetic disk, or an optical disc.

An embodiment of this application further provides a chip. The chip includes a processor and a communications interface, the communications interface is coupled to the processor, and the processor is configured to run a program or an instruction to implement processes of the embodiment of the information transmission method or information indication method, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that in this specification, the term “include”, “comprise”, or any other variant is intended to cover non-exclusive inclusion, so that a process, method, article, or apparatus that includes a series of elements includes not only those elements but also other elements that are not explicitly listed, or includes elements inherent to such a process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A method of information transmission, comprising:
sensing, by a terminal, a resource of first information on an unlicensed band or a shared band, or performing a transmission of first information,
wherein the first information comprises at least one of the following:
N1 pieces of first SL information in frequency division multiplexing (FDM), wherein N1>1;
N pieces of first information in FDM, wherein the N pieces of first information comprise N2 pieces of first SL information and N−N2 pieces of second information, N>1, and N2≥1;
first SL information based on a first parameter; or
first SL information within a first preset time, wherein at least one first transmission exists within the first preset time,
wherein the first SL information comprises a synchronization signal, a broadcast channel, or a synchronization signal block.

2. The method according to claim 1, further comprising:
obtaining at least one item of third information through a first obtaining manner,
wherein the third information comprises at least one of the following:
N1;
G1, wherein G1 is a frequency domain interval between any adjacent first SL information or specific adjacent first SL information in the N1 pieces of first SL information, and G1 determined by being configured, preconfigured, or predefined by a control node is greater than or equal to a first preset value;
a frequency domain position of first SL information;
a number of first SL information;
N;
N2;
G2, wherein G2 is a frequency domain interval between any adjacent first information or specific adjacent first information in the N pieces of first information;
a frequency domain position of second information;
a type of second information;
bandwidth of second information;
a number of second information;
a structure of second information;
a first parameter; or
indication information, wherein the indication information is used to indicate whether a transmission of the first SL information is based on the first parameter,
wherein the first obtaining manner comprises at least one of the following:
being configured by a control node;
being determined by the terminal;
being preconfigured;
being predefined: or
being indicated by another terminal.

3. The method according to claim 2, further comprising:
determining, by the terminal, G1 based on first bandwidth and N1, wherein the first bandwidth is bandwidth associated with the first SL information.

4. The method according to claim 3, wherein determining, by the terminal, G1 based on the first bandwidth and N1 comprises:
determining, by the terminal, G1 by using at least one of the following formulas:
G1=(first bandwidth÷N1);
G1=floor(first bandwidth÷N1), wherein floor is rounded down: or
G1=ceil(first bandwidth÷N1), wherein ceil is rounded up.

5. The method according to claim 1, wherein N1 pieces of first SL information are N1 pieces of same first SL information; or
at least M pieces of first SL information among N1 pieces of first SL information are at least partially different, wherein M>1.

6. The method according to claim 1, wherein the first parameter comprises at least one of the following:
a specific sub-carrier space (SCS);
a specific cyclic prefix (CP);
a first SL sequence;
a specific frequency domain, wherein the specific frequency domain comprises X frequency domain resource units, and X is an integer;
a specific multiplexing manner, wherein the specific multiplexing manner is frequency division multiplexing of a synchronization signal and a broadcast channel; or
an interlace.

7. The method according to claim 6, wherein performing the transmission of the first information comprises:
performing a transmission of the first SL information based on the first parameter when it is satisfied that an SCS of an object associated with the first SL information is a first SCS, bandwidth associated with the first SL information is second bandwidth, and a frequency domain associated with the first SL information is at least one item of a first frequency domain, wherein:
the object associated with the first SL information is SL data, a control channel, or a feedback channel associated with the first SL information, or the object associated with the first SL information is a carrier, a cell, a BWP, an SL resource pool, or a subchannel associated with the first SL information; and
a time unit corresponding to the first SCS comprises W pieces of first SL information or W candidate positions of the first SL information, and W≥1.

8. The method according to claim 7, wherein:
when W=1, duration corresponding to the first SL information or duration corresponding to the candidate position of the first SL information is duration of the time unit corresponding to the first SCS, or duration corresponding to the first SL information or duration corresponding to the candidate position of the first SL information is equal to duration of the time unit corresponding to the first SCS obtained after removing at least one of first duration and second duration,
wherein the first duration comprises duration required for at least one of automatic gain control (AGC) or power adjustment, and the second duration comprises duration required for at least one of a guard period (GP), radio frequency (RF) adjustment, or receive/transmit transition,
when W>1, a time interval between any adjacent pieces of first SL information or candidate positions of the first SL information or between specific two adjacent pieces of first SL information or candidate positions of the first SL information in the time unit corresponding to the first SCS is 0 or Z, wherein Z comprises duration required for at least one of first duration and second duration,
wherein the first duration comprises duration required for at least one of automatic gain control (AGC) or power adjustment, and the second duration comprises duration required for at least one of a guard period (GP), RF adjustment, or receive/transmit transition.

9. The method according to claim 7, wherein a time corresponding to a target subunit in a time unit in which the first SL information or the candidate position of the first SL information is located is equal to or less than a time corresponding to a target subunit in a time unit corresponding to the first SCS, the target subunit comprises at least one of first duration or second duration, the first duration comprises duration required for at least one of automatic gain control (AGC) or power adjustment, and the second duration comprises duration required for at least one of a guard period (GP), RF adjustment, or receive/transmit transition.

10. The method according to claim 6, wherein the interlace comprises J second frequency domain resources, each second frequency domain resource comprises at least two frequency domain resource unit groups, and a frequency domain interval between two adjacent frequency domain resource units is K first frequency domain resources,
wherein each first frequency domain resource or each second frequency domain resource comprises at least one frequency domain resource unit, K≥1, and J≥1.

11. The method according to claim 1, wherein the first SL information indicates target information, and the target information comprises at least one of the following:
a quantity of pieces of first SL information;
a quantity of repetitions of first SL information;
a number of first SL information;
an interlace of first SL information;
an SCS of first SL information;
a sequence of first SL information;
frequency domain bandwidth of first SL information;
a multiplexing manner of first SL information;
information about a synchronization signal, a broadcast channel, or a synchronization signal block other than the first SL information;
information about associated second information;
information about a first preset time;
information about associated first transmission;
information about associated bandwidth; or
information about an associated channel.

12. A method of information indication, comprising:
instructing, by a network side device, a terminal to sense a resource of first information on an unlicensed band or a shared band, or perform a transmission of first information,
wherein the first information comprises at least one of the following:
N1 pieces of first SL information in frequency division multiplexing (FDM), wherein N1>1;
N pieces of first information in FDM, wherein the N pieces of first information comprise N2 pieces of first SL information and N−N2 pieces of second information, N>1, and N2≥1;
first SL information based on a first parameter; or
first SL information within a first preset time, wherein at least one first transmission exists within the first preset time,
wherein the first SL information comprises a synchronization signal, a broadcast channel, or a synchronization signal block;
the first information meets a first transmission requirement; and
the first transmission meets a first transmission requirement.

13. The method according to claim 12, further comprising:
configuring third information and sending the third information to the terminal,
wherein the third information comprises at least one of the following:
N1;
G1, wherein G1 is a frequency domain interval between any adjacent first SL information or specific adjacent first SL information in the N1 pieces of first SL information; and G1 determined by being configured, preconfigured, or predefined by a control node is greater than or equal to a first preset value;
a frequency domain position of first SL information;
a number of first SL information;
N;
N2;
G2, wherein G2 is a frequency domain interval between any adjacent first information or specific adjacent first information in the N pieces of first information;
a frequency domain position of second information;
a type of second information;
bandwidth of second information;
a number of second information;
a structure of second information;
a first parameter; or
indication information, wherein the indication information is used to indicate whether a transmission of the first SL information is based on the first parameter.

14. The method according to claim 12, wherein the first parameter comprises at least one of the following:
a specific sub-carrier space (SCS);
a specific cyclic prefix (CP);
a first SL sequence:
a specific frequency domain, wherein the specific frequency domain comprises X frequency domain resource units, and X is an integer:
a specific multiplexing manner, wherein the specific multiplexing manner is frequency division multiplexing of a synchronization signal and a broadcast channel; or
an interlace.

15. The method according to claim 14, wherein the first parameter is corresponding to at least one of the following:
a first SCS:
second bandwidth; or
a first frequency domain,
wherein the first SCS is an SCS of an object associated with the first SL information, the object associated with the first SL information is SL data, a control channel, or a feedback channel associated with the first SL information, or the object associated with the first SL information is a carrier, a cell, a BWP, an SL resource pool, or a subchannel associated with the first SL information;
the second bandwidth is bandwidth associated with the first SL information; and
a time unit corresponding to the first SCS comprises W pieces of first SL information or W candidate positions of the first SL information, and W≥.

16. The method according to claim 15, wherein:
when W=1, duration corresponding to the first SL information or duration corresponding to the candidate position of the first SL information is duration of the time unit corresponding to the first SCS, or duration corresponding to the first SL information or duration corresponding to the candidate position of the first SL information is equal to duration of the time unit corresponding to the first SCS obtained after removing at least one of first duration and second duration,
wherein the first duration comprises duration required for at least one of automatic gain control (AGC) or power adjustment, and the second duration comprises duration required for at least one of a guard period (GP), radio frequency (RF) adjustment, or receive/transmit transition; and
when W>1, a time interval between any adjacent pieces of first SL information or candidate positions of the first SL information or between specific two adjacent pieces of first SL information or candidate positions of the first SL information in the time unit corresponding to the first SCS is 0 or Z, wherein Z comprises duration required for at least one of first duration and second duration,
wherein the first duration comprises duration required for at least one of automatic gain control (AGC) or power adjustment, and the second duration comprises duration required for at least one of a guard period (GP), RF adjustment, or receive/transmit transition.

17. The method according to claim 15, wherein a time corresponding to a target subunit in a time unit in which the first SL information or the candidate position of the first SL information is located is equal to or less than a time corresponding to a target subunit in a time unit corresponding to the first SCS, the target subunit comprises at least one of first duration or second duration, the first duration comprises duration required for at least one of automatic gain control (AGC) or power adjustment, and the second duration comprises duration required for at least one of a guard period (GP), RF adjustment, or receive/transmit transition.

18. The method according to claim 14, wherein the interlace comprises J second frequency domain resources, each second frequency domain resource comprises at least two frequency domain resource unit groups, and a frequency domain interval between two adjacent frequency domain resource units is K first frequency domain resources,
wherein each first frequency domain resource or each second frequency domain resource comprises at least one frequency domain resource unit, K≥1, and J≥1.

19. The method according to claim 12, wherein the first SL information indicates target information, and the target information comprises at least one of the following:
a quantity of pieces of first SL information;
a quantity of repetitions of first SL information;
a number of first SL information;
an interlace of first SL information;
an SCS of first SL information;
a sequence of first SL information;
frequency domain bandwidth of first SL information;
a multiplexing manner of first SL information;
information about a synchronization signal, a broadcast channel, or a synchronization signal block other than the first SL information;
information about associated second information;
information about a first preset time;
information about associated first transmission:
information about associated bandwidth; or
information about an associated channel.

20. A terminal, comprising: a memory storing a computer program; and a processor coupled to the memory and configured to execute the computer program to perform operations comprising:
sensing a resource of first information on an unlicensed band or a shared band, or performing a transmission of first information,
wherein the first information comprises at least one of the following:
N1 pieces of first SL information in frequency division multiplexing (FDM), wherein N1>1;
N pieces of first information in FDM, wherein the N pieces of first information comprise N2 pieces of first SL information and N−N2 pieces of second information, N>1, and N2≥1;
first SL information based on a first parameter; or
first SL information within a first preset time, wherein at least one first transmission exists within the first preset time,
wherein the first SL information comprises a synchronization signal, a broadcast channel, or a synchronization signal block;
the first information meets a first transmission requirement; and
the first transmission meets a first transmission requirement.
